(19) United States
(12) Patent Application Publication
(10) Pub. No.: US 2025/0196647 A1
(43) Pub. Date: Jun. 19, 2025

(54) MODULAR CONTACTOR BOX

(71) Applicant: Schaltbau GmbH, München (DE)

(72) Inventors: Korbinian Kreuzpointner, Oberding (DE); Lorenz Neuwieser, Albaching (DE); Markus Schreyer, Reichertshausen (DE)

(73) Assignee: Schaltbau GmbH, München (DE)

(21) Appl. No.: 18/846,536

(22) PCT Filed: Mar. 16, 2023
(86) PCT No.: PCT/EP2023/056707

§ 371 Date: Sep. 12, 2024

(30) Foreign Application Priority Data
Mar. 16, 2022 (DE) 10 2022 106 118.3

(51) Int. Cl. B60L 3/00; A62C 3/07; A62C 3/16; B60L 3/04; B60L 50/60

(52) U.S. Cl. CPC B60L 3/0046; A62C 3/07; A62C 3/16; B60L 3/04; B60L 50/60

(57) ABSTRACT

The invention relates to a modular contactor box, in particular for electric vehicles. The object of the invention is to provide a concept with which the required number of contactors can be achieved at low cost and with low space requirements. According to the invention, this object is achieved in that the modular contactor box comprises a module housing with a plurality of plug-in points for receiving a respective contactor module, at least two contactor modules with a respective at least two contactor module connection contacts, wherein each contactor module is accommodated in one of the plug-in points of the module housing, and at least two contactor box connection contacts, wherein at least two of the contactor modules are connected internally with one another in such a way that the maximum number of contactor box connection contacts is lower than the number of contactor module connection contacts by at least 1.

The present invention relates to a modular contactor box, in particular for electric vehicles.

The latest climate and environmental protection goals can only be achieved if road traffic also renders a significant contribution. One important component in this regard is the growing trend towards electric drives in all vehicle classes. This affects all areas, from private transport to public transport and commercial transport. For commercial transport, electric vehicles offer other compelling advantages in addition to the most important aspect of environmentally friendly driving: in direct comparison, the drive of an electric vehicle requires significantly less maintenance and its service life is noticeably longer than that of conventionally powered vehicles. This results in significantly higher efficiency, especially for short and medium distances.

Electric vehicles are powered by an electric motor that draws its energy from a high-capacity battery unit. The battery unit is charged at charging stations. To enable safe connection and disconnection of the battery unit to both the electric vehicle drive and a charging station, each electric vehicle has a power supply system with a plurality of contactors. Depending on the application, 5 to 9 contactors can be provided. This results in increased space requirements and thus also in-creased costs.

The object of the present invention is therefore to provide a concept with which the required number of contactors can be achieved with the required safety while also reducing costs and space requirements.

For this purpose, a modular contactor box is provided in accordance with the invention, comprising a module housing with a plurality of accommodation points for accommodating one contactor module in each case, at least two contactor modules with at least two contactor module connection contacts in each case, wherein each contactor module is accommodated in one of the accommodation points of the module housing, and at least two contactor box connection contacts, wherein at least two of the contactor modules are connected internally with one another in such a way that the number of contactor box connection contacts is lower than the number of contactor module connection contacts by at least 1.

“Modular contactor box” means that the contactor box is configured in the manner of a construction kit. The required components, in particular a plurality of contactor modules, are provided, which may be configured in the same way, but may also differ from one another depending on the required application. The required components/contactor modules are selected from this number of similar or different components, in particular contactor modules, depending on the application.

The module housing has a plurality of accommodation points into which the required contactor modules can simply be inserted. Preferably, the external dimensions of the contactor modules can be configured identically, in which case the accommodation points are also configured identically. However, contactor modules with different external dimensions can also be provided, in which case the accommodation points in the module housing are adapted accordingly. This ensures a simple structure and thus easy assembly of the contactor box. Because the external dimensions of the contactor modules are as identical as possible, identical parts can be used, with the associated potential savings in terms of costs. Preferably, the contactor modules are prefabricated or existing units that can be easily used. By integrating the contactor modules into the contactor box, installation space is saved, which also leads to a cost reduction. Nevertheless, adaptations to customer-specific requirements are possible.

The contactor module connection contacts are the connection contacts of a contactor module, with which the contactor module is connected to the line to be interrupted. Furthermore, each contactor module also has switching contacts, preferably at least one movable contact and one fixed contact. The contactor box connection contacts are the connection contacts that lead out of the contactor box module housing and enable the components of the contactor box to be connected to external lines. Since at least two of the contactor modules are connected to each other internally, so that the number of contactor box connection contacts is at least lower by 1 than the number of contactor module connection contacts, additional electrical connections with connection conductors, e.g. screw connections, are no longer required. This makes it possible to reduce electrical losses. If more than two of the contactor modules are connected to each other internally, the number of contactor box connection contacts is correspondingly lower. The contactor module connection contacts can be integrated into the contactor box connection contacts or configured integrally with them.

Preferred embodiments of the present invention are the subject-matter of the sub-claims.

In a preferred embodiment, the contactor modules that are connected internally with one another are connected with one another via a common connection element forming the contactor module connection contacts. The connection element also preferably forms a contactor box connection contact. The connection element can be configured as a busbar, for example, and thus as a metal sheet or rail made of copper or aluminum. This enables a simple and robust configuration. Furthermore, the fixed contacts of the contactor modules can also be configured on the busbar. Since the contactor modules are connected internally with one another, an additional contact point is not needed in the system. This leads to a reduction in contact resistance.

In a further embodiment, it may be provided that more than two contactor modules are connected internally to one another, preferably by means of a common connection element configured as a multiple bridge. This saves further contact points in the system, with the advantages described above.

Advantageously, it may be provided that the contactor modules can be plugged into the accommodation points. The accommodation points are then configured as plug-in points so that the contactor modules can simply be plugged into the plug-in points during assembly. Preferably, latching or fastening of the contactor modules in the plug-in points is also possible.

Another preferred embodiment may provide that each contactor module has at least one movable contact and at least one fixed contact and that the at least one fixed contact of at least one contactor module has grooves running transversely to a closing direction of the contacts of the at least one contactor module, wherein the groove flanks of the grooves run at least partially obliquely with respect to the closing direction, so that the groove flanks form an angle with respect to the closing direction that is not equal to 90°, and wherein the at least one movable contact of the at least one contactor module is configured such that the contact between the fixed contacts and the movable contacts at the groove flanks running obliquely is produced in the closed position of the contacts of the at least one contactor module. This avoids additional contacts, which leads to a reduction in material, weight and construction volume, as well as reduced transition resistance. In addition, the short-circuit strength is increased.

Further savings in installation space can be achieved by configuring in the module housing at least one extinguishing area for extinguishing electric arcs that occur when the contactor modules switch.

Advantageously, the at least one extinguishing area can be assigned to at least two contactor modules. These are contactor modules that do not switch at the same time. The fact that the extinguishing area is used by two or more contactor modules further optimizes the space requirement.

In another preferred embodiment, it may be provided that at least one fuse is arranged in the module housing. By integrating a further component in the contactor box, the assembly in the vehicle is further simplified and the space requirement is optimized.

This can also be achieved by arranging at least one pyro switch in the module housing. These configurations also increase safety.

Further simplification of the assembly can be achieved in that the contactor box further comprises a plug interface and/or in that sensors for measuring current are arranged in the module housing and/or in that tapping points for measuring voltage are arranged in the module housing.

According to yet another variant, it may be provided that at least one of the contactor modules has at least one fixed contact and at least one movable contact, as well as a coil for driving the at least one movable contact, wherein the coil has coil connections and all the coil connections are arranged on the module housing and can be jointly contacted. In this context, the coils of the contactor modules can be controlled individually. This also leads to cost savings with regard to the parts used and during assembly. The coil connections can be controlled advantageously via a printed circuit board or a lead frame.

Yet another preferred embodiment may provide that the contactor box comprises a common control module arranged on the module housing. The control module can be installed at various installation locations and enables common control of the components arranged in the contactor box.

Embodiments of the present invention will be explained in more detail in the following by means of drawings.

It is shown by:

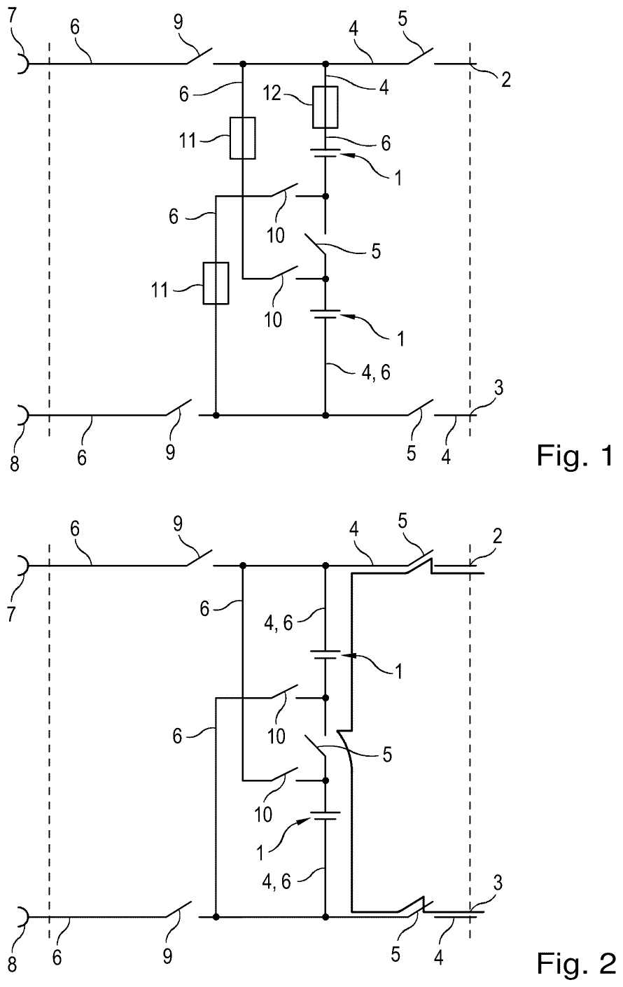

FIG. 1: a schematic illustration of the electrical connections of batteries in an electric vehicle,

FIG. 2: a schematic illustration of the electric vehicle in operation, as shown in FIG. 1,

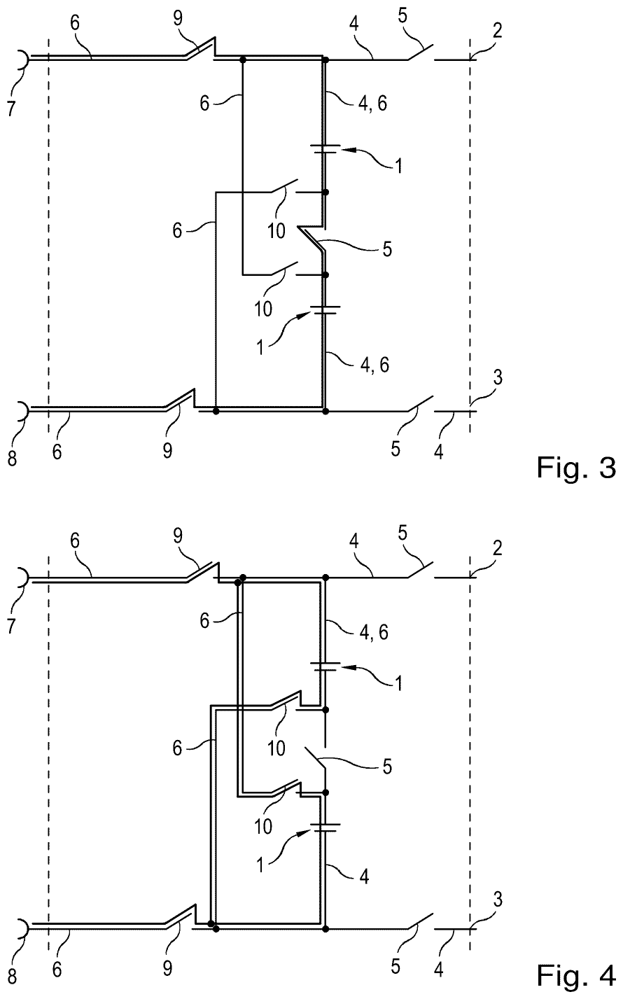

FIG. 3: a schematic illustration according to FIG. 1 when charging the electric vehicle with 800 V,

FIG. 4: a schematic illustration according to FIG. 1 when charging the electric vehicle with 400 V,

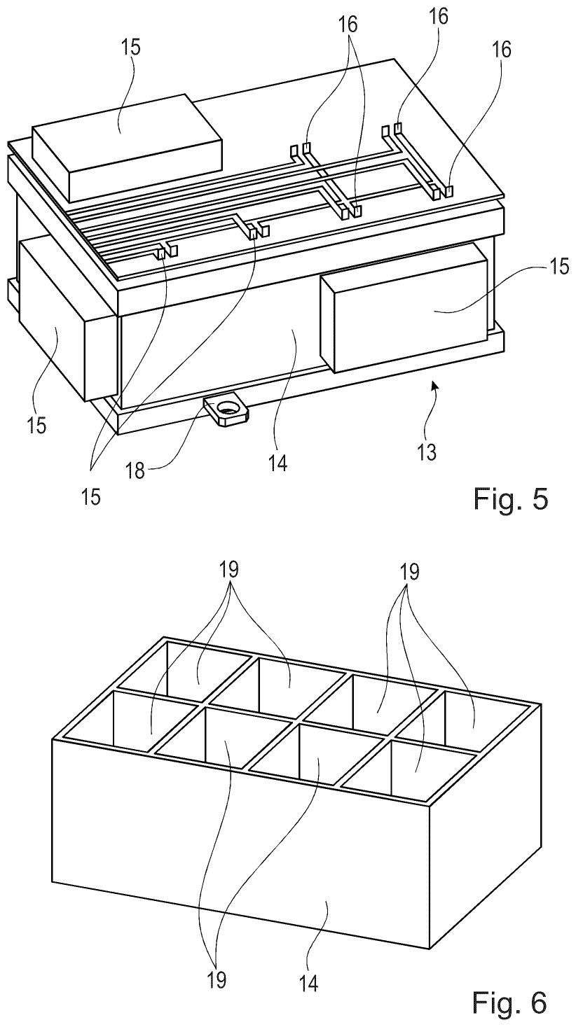

FIG. 5: a schematic illustration of a modular contactor box for an electric vehicle,

FIG. 6: the module housing of the contactor box from FIG. 5,

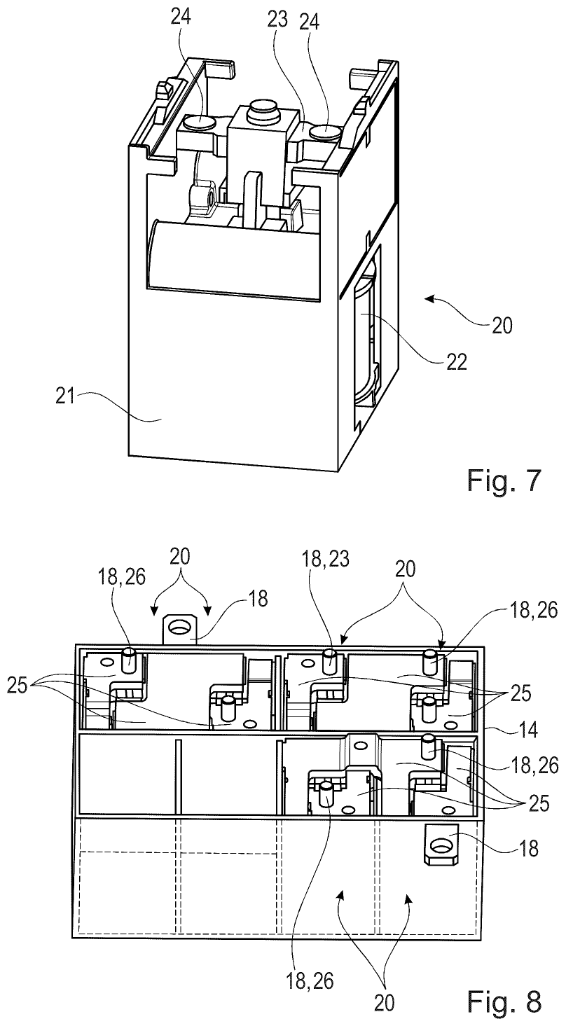

FIG. 7: a contactor module of the contactor box from FIG. 5, and

FIG. 8: top view of the contactor box from FIG. 5.

For the following explanations, the same parts are characterized by the same reference signs. If a Figure contains reference signs that are not explained in detail in the associated Figure description, reference is made to the preceding or subsequent Figure descriptions.

In an electric vehicle, contactors are necessary to charge the battery at different networks or charging stations or to couple it to the electric motor. FIG. 1 is a schematic illustration of possible electrical connections of the batteries 1 in an electric vehicle. The electric vehicle has two batteries 1. The batteries 1 can be connected to the drive or the motor of the electric vehicle via vehicle connections 2, 3. Vehicle connection lines 4 are provided between the batteries 1 and the vehicle connections 2, 3. Three main contactors 5 are arranged in the vehicle connection lines 4. Furthermore, the batteries 1 can be connected to charging connections 7, 8 via charging connection 15 lines 6. Two first charging contactors 9 for charging the batteries with 800 V and two second charging contactors 10 for charging the batteries with 400 V are provided in the charging connection lines 6. In addition, fuses 11 and/or pyro-switches 12 can be arranged in the charging connection lines 6 and/or in the vehicle connection lines 4.

FIG. 2 shows the electrical connections of the batteries 1 when the electric vehicle is in a driving state. In this state, the batteries 1 are connected to the vehicle connections 2, 3. The three main contactors 5 arranged in the vehicle connection lines 4 are thus closed, so that the batteries 1 can supply the electric vehicle or the drive of the electric vehicle with current. The first charging contactors 9 and the second charging contactors 10 are open.

FIG. 3 shows an initial charge state of the batteries 1. In this case, the batteries 1 are electrically connected to the charging connections 7, 8 via the charging connection lines 6. For this purpose, both the first charging contactors 9 and the main contactor 5 arranged between the two batteries 1 are closed. The second charging contactors 10 are open, as are the two main contactors 5 that lead to the vehicle connections 2, 3. The batteries 1 are therefore connected to the charging station in a series circuit. This enables the batteries 1 of the electric vehicle to be charged with 800 V.

A second option for charging the batteries 1 of the electric vehicle is shown in FIG. 4. In this case, both the first charging contactors 9 and the second charging contactors 10 are closed. All three main contactors 5 are open. The batteries 1 are thus connected to the charging station in a parallel circuit. This enables the batteries 1 of the electric vehicle to be charged with 400 V.

As can be seen from FIGS. 1 to 4, several contactors are necessary in an electric vehicle to enable the batteries 1 to be charged at different networks or charging stations and to couple the batteries to the drive of the electric vehicle, i.e. the electric motor. In FIGS. 1 to 4, seven contactors are provided: the three main contactors 5, the first two charging contactors 9 and the second two charging contactors 10. In further applications, more or fewer contactors may be provided, for example five to nine contactors.

In order to save installation space and to simplify assembly, the contactors of the electric vehicle, i.e. the main contactors 5, the first charging contactors 9 and the second charging contactors 10, are each configured as a contactor module, which are arranged in a modular contactor box 13. The modular contactor box 13 is shown in FIG. 5. A contactor module is understood to mean that the contactors are configured to be as identical as possible or contain as many identical components as possible, so that cost-effective production is possible. Depending on the application, the required contactor modules are selected and inserted into the modular contactor box 13. For this purpose, the modular contactor box 13 includes a module housing 14. The module housing 14 is described in more detail below with reference to FIG. 6. The contactor modules are inserted into the module housing 14. In order to minimize electrical losses, space requirements and costs, at least two of the contactor modules arranged in the contactor box are connected internally, i.e. in the contactor box 13, with one another. This is described in more detail below with reference to FIGS. 6 to 8. Each of the contactor modules has at least two contactor module connection contacts. The contactor module connection contacts are the contacts of each contactor module with which it is connected to the line to be interrupted. At least one of the contactor modules has an electromagnetic drive, preferably a coil. Each coil is provided with coil connections 16. The coil connections 16 are routed outwards through the module housing 14 and can be contacted together via a printed circuit board/lead frame 17. The coils of the individual contactor modules can be controlled individually. In addition, a contactor box connection contact 18 is shown in FIG. 5. The modular contactor box 13 can also have several contactor box connection contacts, wherein the maximum number of contactor box connection contacts is always at least lower by 1 than the number of contactor module connection contacts of all contactor modules arranged in the contactor box. In addition, the modular contactor box 13 can include a control assembly 15 that is attached to the module housing 14. FIG. 5 shows three possible installation positions for the control assembly 15. For example, the control assembly 15 can be arranged on one of the side walls of the module housing 14. However, it is also conceivable that the control assembly is mounted on the printed circuit board/lead frame 17.

FIG. 6 shows the module housing 14 of the modular contactor box 13 from FIG. 5. The module housing 14 is configured as a compartment housing. This means that the module housing 14 has a plurality of compartments or accommodation points 19. Eight accommodation points 19 are shown in FIG. 6. Each of the accommodation points 19 is configured in such a way that a contactor module can be easily inserted and, advantageously, also latched.

FIG. 7 exemplarily shows a contactor module 20 of the modular contactor box 13 from FIG. 5. At least the external dimensions of all contactor modules 20 that can be inserted into the contactor box 13 are preferably configured identically. However, it can also be provided that a plurality or all of the contactor modules 20 are completely identical in construction. Each of the contactor modules 20 has a contactor housing 21. The contactor housing 21 and the accommodation points 19 of the module housing 14 are matched to one another so that each of the contactor housings 21 can be easily inserted, preferably plugged, into each of the accommodation points 19 of the module housing 14.

An electromagnetic drive with a coil 22 is arranged in the contactor housing 21. A contact bridge 23 can be moved by means of the electromagnetic drive. Two movable contacts 24 are formed on the contact bridge 23. Each of the movable contacts 24 interacts with one fixed contact, respectively. Each of the fixed contacts is connected to a contactor module connection contact. It may also be provided that the fixed contacts are formed on the contactor module connection contact or are integrally connected thereto (not shown).

FIG. 8 shows a top view of the module housing 14 with the contactor modules 20 arranged in it. As already described, the module housing 14 has eight accommodation points 19 for receiving one contactor module 20 each. A contactor module 20 is inserted in six of the accommodation points 19. Two accommodation points 19 are empty. The contactor modules 20 are configured in accordance with the embodiment shown in FIG. 7. In addition, each contactor module 20 has two fixed contacts which interact with the two movable contacts 24 arranged on the contact bridge 23.

As can be clearly seen in FIG. 8, two of the contactor modules 20 are connected internally, i.e. in the contactor box 13, with one another. Connection elements 25 are provided for this purpose, wherein two fixed contacts are formed on each of the connection elements 25 and these two fixed contacts are assigned to two different contactor modules 20. The connection elements 25 form one contactor module connection contact for each of the contactor modules 20 that they connect. If a connection element connects two contactor modules, this connection element forms two contactor module connection contacts.

The connection elements 25 can be configured as a busbar. In addition, each of the connection elements 25 has an outward-pointing contactor box connection contact 18. The contactor box connection contacts 18 can be configured as a connection lug or as a contact pill 26. The other fixed contact of the respective contactor module 20 is also formed on a busbar and forms a contactor module connection contact. In the case shown in FIG. 8, the contactor module connection contacts, which are not formed on the connection elements 25, are integrated into contactor box connection contacts 18, wherein the contactor box connection contacts 18 have a contact pill 26 that leads out of the module housing 14 and enables an external connection. As can be seen in FIG. 8, the two upper connection elements 25 are configured in an approximately Z-shaped manner. The connection element 25 at the bottom in FIG. 8 is F-shaped and bridges a fixed contact/busbar located below it. It is also possible for the connection elements to be configured as a multiple bridge and to connect more than two contactor modules to one another.

The fixed contacts of at least one of the contactor modules can have grooves running transversely to a closing direction of the contacts of the contactor modules, wherein the groove flanks of the grooves run at least partially obliquely with respect to the closing direction, so that the groove flanks form an angle that is not equal to 90° with respect to the closing direction, and wherein the movable contacts of the contactor modules are configured such that the contact existing in the closed position of the contacts of the contactor modules between the fixed contacts and the movable contacts is produced at the obliquely running groove flanks.

Furthermore, it may be provided that the fuses or pyro-switches shown in FIGS. 1 to 4 are integrated into the contactor box, that the contactor box comprises a plug interface and that sensors for measuring current and tapping points for measuring voltage are arranged in the module housing.

In addition, at least one extinguishing area can be formed in the module housing for extinguishing electric arcs that occur during a switching operation of the contactor modules. Since the pressure drop when the contactor modules are switched off occurs relatively quickly according to the Paschen law, an extinguishing area with a small volume can be sufficient. This achieves a reduction of the required installation space. In order to further reduce the volume of the contactor box, it can be provided that the extinguishing area is assigned to at least two contactor modules.

### LIST OF REFERENCE SIGNS

1 battery
2, 3 vehicle connection
4 vehicle connection line
5 main contactor
6 charging connection line
7,8 charging connections
9 first charging contactors
10 second charging contactors
11 fuses
12 pyro-switches
13 contactor box
14 module housing
15 control assembly
16 coil connections
17 printed circuit board/lead frame
18 connection contacts
19 plug-in point
20 contactor module
21 contactor housing
22 coil
23 contact bridge
24 movable contacts
25 connection elements
26 contact pill

1. A modular contactor box (13), in particular for electric vehicles, comprising:
a module housing (14) with a plurality of accommodation points (19) for accomodating one respective contactor module (20),
at least two contactor modules (20) with a respective at least two contactor module con-nection contacts, wherein each contactor module (20) is accommodated in one of the accommodation points (19) of the module housing (14), and
at least two contactor box connection contacts (18), wherein at least two of the contactor modules (20) are connected internally with one another in such a way that the maximum number of contactor box connection contacts (18) is lower than the number of contactor module connection contacts by at least 1.

2. The contactor box (13) according to claim 1, characterized in that the contactor modules (20) that are connected internally with one another are connected to one another via a common connection element (25) that forms the fixed contacts.

3. The contactor box according to claim 1, characterized in that more than two contactor modules are connected internally with one another, preferably by means of a common connection element configured as a multiple bridge.

4. The contactor box (13) according to claim 1, characterized in that the contactor modules (20) can be plugged into the accommodation points (19).

5. The contactor box (13) according to claim 1, characterized in that each contactor module (20) has at least one movable contact and at least one fixed contact and the at least one fixed contact of at least one contactor module (20) has grooves running transversely to a closing direction of the contacts of the at least one contactor module (20), wherein the groove flanks of the grooves are at least partially obliquely in relation to the closing direction, so that the groove flanks form an angle with the closing direction that is not equal to 90°, and wherein the at least one movable contact (24) of the at least one contactor module is configured such that the contact, which exists in the closed position of the contacts of the at least one contactor module (20), between the fixed contacts and the movable contacts is produced at the obliquely extending groove flanks.

6. The contactor box (13) according to claim 1, characterized in that at least one extinguishing area for extinguishing electric arcs which occur during a switching operation of the contactor modules (20) is formed in the module housing (14).

7. The contactor box (13) according to claim 6, characterized in that the at least one extinguishing area is assigned at least two contactor modules (20).

8. The contactor box (13) according to claim 1, characterized in that at least one fuse is arranged in the module housing (14).

9. The contactor box (13) according to claim 1, characterized in that at least one pyro-switch is arranged in the module housing (14).

10. The contactor box (13) according to claim 1, further comprising a plug-in interface.

11. The contactor box (13) according to claim 1, characterized in that sensors for measuring a current are arranged in the module housing.

12. The contactor box (13) according to claim 1, characterized in that tapping points for measuring a voltage are arranged in the module housing.

13. The contactor box (13) according to claim 1, characterized in that at least one of the contactor modules (20) has a coil (22) for driving the movable contacts (24), wherein the coil (22) has coil connections (16) and all the coil connections (16) are arranged on the module housing (14) and can be contacted together.

14. The contactor box (13) according to claim 1, further comprising a common control assembly (15) arranged on the module housing (14).
